(19) United States
(12) Patent Application Publication
(10) Pub. No.: US 2006/0112316 A1
(43) Pub. Date: May 25, 2006

(54) METHOD OF MONITORING STATUS OF PROCESSOR

(76) Inventor: Jui-Kuo Chiang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/904,619

(22) Filed: Nov. 18, 2004

(51) Int. Cl. G06F 11/00

(52) U.S. Cl. 714/47

(57) ABSTRACT

A method of monitoring interrupts transmitted between a processor and a computer used for verifying the processor. The computer and the processor communicate with each other through an interconnect circuit. The method includes detecting a first interrupt transmitted either from the computer to the processor or from the processor to the computer, measuring a period of time since the first interrupt was generated, comparing the period of time since the first interrupt was generated with a reference time period if the first interrupt has not yet been cleared, resetting the interconnect circuit to clear the first interrupt, and transmitting a second interrupt to the computer to notify the computer that the first interrupt was cleared.

### BACKGROUND OF INVENTION

1. Field of the Invention

The present invention relates to a method of monitoring a status of a processor, and more specifically, to a method of monitoring a processor with a monitor circuit.

2. Description of the Prior Art

When testing and debugging a processor, such as a digital signal processor (DSP) or a micro controller unit (MCU), there are many scenarios and conditions that an engineer needs to verify. Unfortunately, in a traditional testing setup, many of these conditions are difficult and inconvenient to test, requiring the engineer to expend a great deal of time and energy to fully verify the processor or DSP.

Please refer to FIG. 1. FIG. 1 is a block diagram of a test setup 10 for a DSP 16 according to the prior art. The DSP 16 is connected to a host computer 12 through a peripheral component interconnect (PCI) bus controller circuit 14. Executable code for the DSP 16 is stored in a non-volatile memory such as a flash memory 18. The host computer 12 communicates with the DSP 16 through a PCI bus 13 connecting the host computer 12 and the PCI bus controller 14, and through a local bus 15 connecting the PCI bus controller 14 and the DSP 16. The DSP 16 can send interrupts to the host computer 12 using a PCI interrupt INTA. The host computer 12 sends interrupts to the DSP 16 via the PCI bus controller 14 using a local interrupt LINT. Unfortunately, testing and debugging the DSP 16 using the test setup 10 involves several problems and difficulties.

For instance, when the engineer in charge of testing the DSP 16 wishes to change the boot mode or the clock rate of the DSP 16, the engineer must flip a hardware switch such as a dipswitch to change the settings of the DSP 16. If the hardware switches reside inside a case of the host computer 12, the case needs to be opened up to change the switch settings. In addition, the host computer 12 may have to be reset for the new settings to take effect. In order to verify the new clock rate of the DSP 16, the engineer must use an oscilloscope to measure the frequency of a clock DSP CLKOUT output from the DSP 16.

Another problem results when the executable code located in the flash memory 18 needs to be updated by the host computer 12. In this case, the new executable code is sent from the host computer 12 to the PCI bus controller 14 through the PCI bus 13. The PCI bus controller 14 then sends the new executable code to a Joint Test Action Group (JTAG) control chip 17. The JTAG control chip 17 sends the new executable code to the DSP 16, and the DSP 16 in turns updates the flash memory 18 with the new executable code. Unfortunately, the use of the JTAG control chip 17 adds complexity and extra cost to the test setup 10.

In addition, there are occasionally problems with the PCI interrupt INTA or the local interrupt LINT not being cleared properly, and becoming halted. When the local interrupt LINT becomes halted, the DSP 16 cannot receive another interrupt from the host computer 12. Likewise, when the PCI interrupt INTA becomes halted, the host computer 12 cannot receive another interrupt from the DSP 16. In this case, the engineer must manually reset the PCI bus controller 14 to clear either or both of the interrupts.

### SUMMARY OF INVENTION

It is therefore an objective of the claimed invention to provide a method for monitoring a status of a processor in order to solve the above-mentioned problems.

According to the claimed invention, a method of monitoring interrupts transmitted between a processor and a computer used for verifying the processor is disclosed. The computer and the processor communicate with each other through an interconnect circuit. The method includes detecting a first interrupt transmitted either from the computer to the processor or from the processor to the computer, measuring a period of time since the first interrupt was generated, comparing the period of time since the first interrupt was generated with a reference time period if the first interrupt has not yet been cleared, resetting the interconnect circuit to clear the first interrupt, and transmitting a second interrupt to the computer to notify the computer that the first interrupt was cleared.

According to the claimed invention, a method of using a computer to verify a clock frequency of a processor is disclosed. The computer and the processor communicate with each other through an interconnect circuit. The method includes reading a processor clock output from the processor, counting a number of clock periods of the processor clock occurring during a predetermined number of clock periods of a known clock with a known frequency, transmitting the counted number of clock periods of the processor clock to the computer through the interconnect circuit, the computer dividing the counted number of clock periods of the processor clock by the predetermined number of clock periods of the known clock to calculate a clock ratio, and the computer multiplying the clock ratio by the known frequency of the known clock to calculate the frequency of the processor clock.

According to the claimed invention, a method of using a computer to update the executable code of a processor is disclosed. The executable code of the processor is stored in a non-volatile memory electrically connected to the processor, and the computer and the processor communicate with each other through an interconnect circuit. The method includes transmitting new code data from the computer to a memory buffer, transmitting the new code data from the memory buffer directly to the non-volatile memory to update the code data, reading the updated code data from the non-volatile memory to verify that the updated code data is equivalent to the new code data stored in the memory buffer, transmitting an interrupt to the computer to notify the computer that the code data was successfully updated, the computer transmitting a reset command to the processor for resetting the processor, and the processor executing the updated code data stored in the non-volatile memory after the processor is reset.

It is an advantage of the claimed invention that the interconnect circuit is automatically reset if the first interrupt has not been cleared after a certain amount of time. This saves an engineer the trouble of monitoring the first interrupt and manually resetting the interconnect circuit if the first interrupt has not been cleared.

It is another advantage of the claimed invention that the computer automatically calculates the clock frequency of the processor for eliminating the need to use an oscilloscope to measure the clock frequency.

It is another advantage of the claimed invention that the new code data is transmitted directly from the memory buffer to the non-volatile memory for updating the code data. This eliminates the need for a JTAG control chip, thereby reducing the cost and simplifying the design of a test setup for the processor.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a test setup for a DSP according to the prior art.

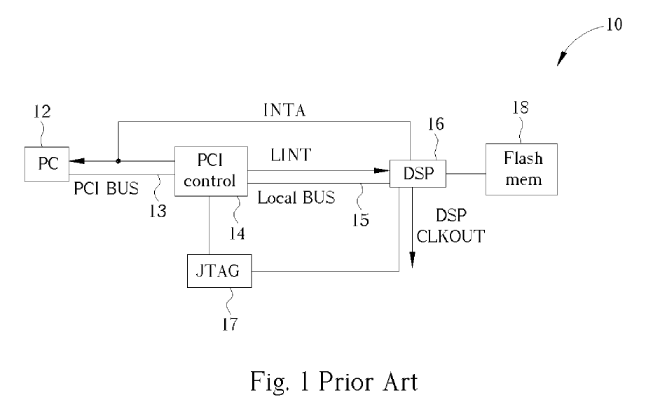

FIG. 2 is a block diagram of a test setup for a processor according to the present invention.

FIG. 3 is a detailed functional block diagram of the monitor circuit.

FIG. 4 shows logic circuitry of counters located in the monitor circuit that are used for calculating the frequency of the DSP clock.

FIG. 5 is a flowchart illustrating a method for calculating the frequency of the DSP clock according to the present invention.

FIG. 6 is a flowchart illustrating a method for updating executable code of the DSP according to the present invention.

FIG. 7 is a flowchart illustrating a method for monitoring the PCI interrupt INTA or a local interrupt LINT in the test setup.

### DETAILED DESCRIPTION

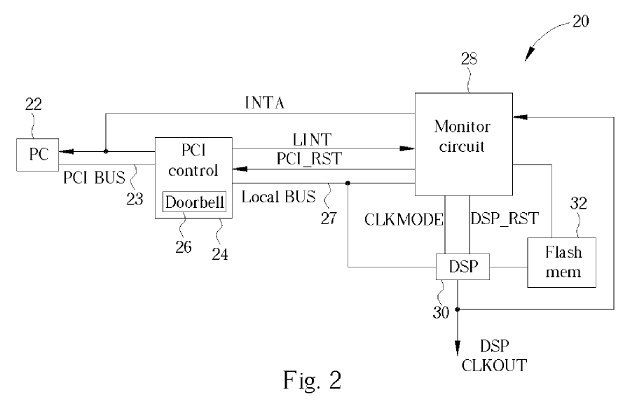

Please refer to FIG. 2. FIG. 2 is a block diagram of a test setup 20 for a processor according to the present invention. The processor can be a micro controller unit (MCU) or a digital signal processor (DSP) 30, although the DSP 30 will be used as an example in the following description.

As in the test setup 10 of the prior art, the test setup 20 of the present invention also contains a PCI bus controller 24 and a non-volatile memory such as a flash memory 32. In addition, the present invention test setup 20 also contains a monitor circuit 28 for monitoring the status of the DSP 30, especially while testing and debugging the DSP 30.

A host computer 22 used for testing and debugging the DSP 30 communicates with the DSP 30 through the PCI bus controller 24. A PCI bus 23 connects the host computer 22 and the PCI bus controller 24, and a local bus 27 connects the PCI bus controller 24 to the DSP 30. In addition, the local bus 27 is connected to the monitor circuit 28.

In the present invention test setup 20, the monitor circuit 28 can easily set the boot mode and the clock rate of the DSP 30 through software. The monitor circuit 28 adjusts the boot mode of the DSP 30 through the use of the local bus 27. Furthermore, the monitor circuit 28 adjusts the clock rate of the DSP 30 in software through CLKMODE pins that are connected between the monitor circuit 28 and the DSP 30. Therefore, with the present invention test setup 20, no hardware switches or dipswitches need to be manually set by the engineer testing the DSP 30. This means that the case of the host computer 22 does not need to be opened up, and the host computer 22 does not need to be reset to change the boot mode or the clock rate of the DSP 30. A frequency of a clock DSP CLKOUT that is output from the DSP 30 is fed back to the monitor circuit 28 for allowing the monitor circuit 28 in conjunction with the host computer 22 to measure the frequency of the clock DSP CLKOUT.

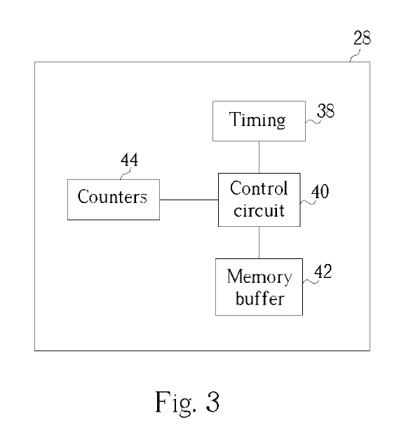

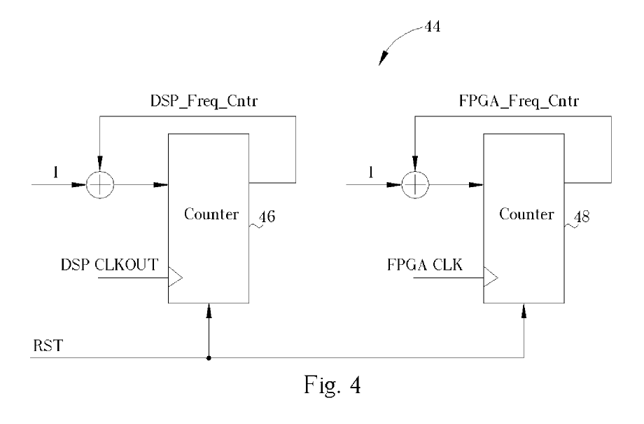

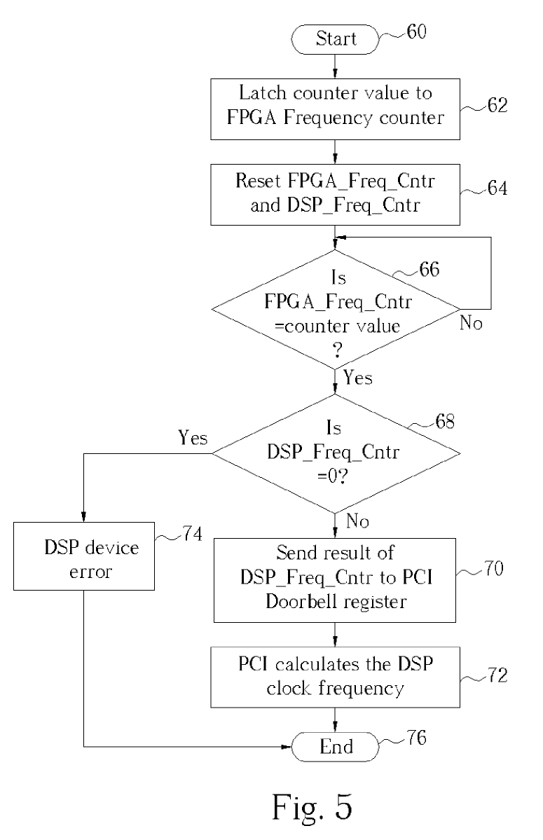

Please refer to FIGS. 2-5. FIG. 3 is a detailed functional block diagram of the monitor circuit 28. FIG. 4 shows logic circuitry of counters 44 located in the monitor circuit 28 that are used for calculating the frequency of the clock DSP CLKOUT. FIG. 5 is a flowchart illustrating a method for calculating the frequency of the clock DSP CLKOUT according to the present invention. A control circuit 40 of the monitor circuit 28 controls all activity of the monitor circuit 28. As shown in FIG. 4, in order to calculate the frequency of the clock DSP CLKOUT, the clock DSP CLKOUT must be compared to a known clock frequency. If the monitor circuit 28 is implemented in a field programmable gate-array (FPGA), the known clock frequency generated by the FPGA can be used for measuring the frequency of the clock DSP CLKOUT.

The counters 44 illustrated in FIG. 4 contain a first counter 46 and a second counter 48. Whenever the first counter 46 receives a clock pulse from the DSP CLKOUT clock, a counting value DSP_Freq_Cntr is incremented by one. Similarly, whenever the second counter 48 receives a clock pulse from the known FPGA CLK clock, a counting value FPGA_Freq_Cntr is also incremented by one.

The entire method for calculating the frequency of the clock DSP CLKOUT is outlined in FIG. 5. Steps contained in the flowchart will be explained below.

Step 60: Start;

Step 62: The engineer operates the host computer 22 to latch a predetermined counter value to the second counter 48 used for calculating the clock pulses of the known FPGA CLK clock. The predetermined counter value is sent to the second counter 48 via the PCI BUS 23, the PCI bus controller 24, and the local bus 27;

Step 64: The monitor circuit 28 issues a reset command RST to reset the counting values DSP_Freq_Cntr and FPGA_Freq_Cntr that are respectively output by the first and second counters 46 and 48;

Step 66: Determine if the counting value FPGA_Freq_Cntr is equal to the predetermined counter value; if so, go to step 68; if not, continue checking in step 66;

Step 68: Determine if the counting value DSP_Freq_Cntr is equal to zero; if so, go to step 74; if not, go to step 70;

Step 70: Send the result of the counting value DSP_Freq_Cntr to a Doorbell register 26 of the PCI bus controller 24. The monitor circuit 28 then sends an interrupt to the host computer 22 through a PCI interrupt INTA to inform the host computer 22 that the counting value DSP_Freq_Cntr is in the Doorbell register 26;

Step 72: The host computer 22 calculates the frequency of the clock DSP CLKOUT. To perform this calculation, a clock ratio is first computed by dividing the counting value DSP_Freq_Cntr by the counting value FPGA_Freq_Cntr. The host computer 22 then multiplies the clock ratio by the known frequency of the known FPGA CLK clock to calculate the frequency of the clock DSP CLKOUT; go to step 76;

Step 74: The monitor circuit 28 returns an error code to the host computer 22 through the PCI interrupt INTA. The error code states that there was an error in calculating the frequency of the clock DSP CLKOUT; and

Step 76: End.

Using the present invention test setup 20, the frequency of the clock DSP CLKOUT can be calculated by the monitor circuit 28 and the host computer 22 in real-time. This eliminates the need for using an oscilloscope for measuring the frequency of the clock DSP CLKOUT as was done in the prior art.

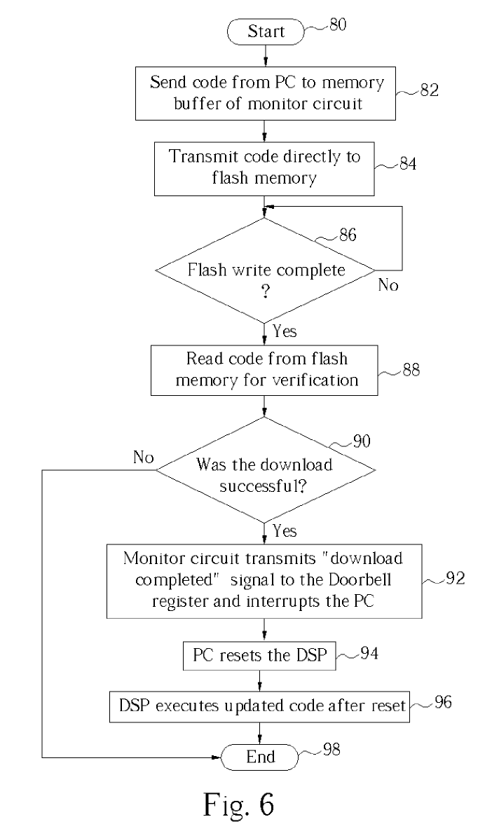

Please refer to FIG. 2, FIG. 3, and FIG. 6. FIG. 6 is a flowchart illustrating a method for updating executable code of the DSP 30 according to the present invention. With the use of the monitor circuit 28, the present invention test setup 20 does not require the JTAG control chip that was used in the prior art test setup 10. Instead, new executable code is sent from the host computer 22 to a memory buffer 42 of the monitor circuit 28 via the PCI bus controller 24. The monitor circuit 28 then sends the new executable code directly from the memory buffer 42 to the flash memory 32. Steps contained in the flowchart will be explained below.

Step 80: Start;

Step 82: The host computer 22 sends new executable code to the memory buffer 42 of the monitor circuit 28 via the PCI bus controller 24;

Step 84: The monitor circuit 28 transmits the code from the memory buffer 42 directly to the flash memory 32;

Sep 86: Determine if the new executable code is finished being written to the flash memory 32; if so, go to step 88; if not, continue checking in step 86;

Step 88: The monitor circuit 28 reads the executable code stored in the flash memory 32 for comparison with the executable code stored in the memory buffer 42;

Step 90: Determine if the new executable code was successfully downloaded based on the verification performed in step 88; if so, go to step 92; if not, go to step 98;

Step 92: Since the download of the new executable code was completed successfully, the monitor circuit 28 transmits a “download completed” signal to the Doorbell register 26 of the PCI bus controller 24 and informs the host computer 22 with an interrupt;

Step 94: The host computer 22 resets the DSP 30. To accomplish this, the host computer 22 sends a command to the monitor circuit 28 through the PCI bus 23, the PCI bus controller 24, and the local bus 27. The monitor circuit 28 then resets the DSP 30 using a DSP reset command DSP_RST sent from the monitor circuit 28 to the DSP 30;

Step 96: After the DSP 30 is reset, the DSP 30 executes the new executable code stored in the flash memory 32; and

Step 98: End.

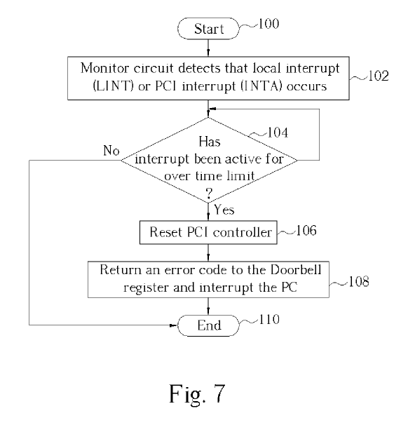

Please refer to FIG. 2, FIG. 3, and FIG. 7. FIG. 7 is a flowchart illustrating a method for monitoring the PCI interrupt INTA or a local interrupt LINT in the test setup 20. The monitor circuit 28 contains a timing circuit 38 for detecting when the PCI interrupt INTA or the local interrupt LINT has become halted. That is, when the PCI interrupt INTA or the local interrupt LINT has not been cleared for a certain amount of time, the monitor circuit 28 will detect this situation and take action to clear the halted interrupt. Steps contained in the flowchart will be explained below.

Step 100: Start;

Step 102: The monitor circuit 28 detects that one or both of the PCI interrupt INTA or the local interrupt LINT has occurred. The timing circuit 38 of the monitor circuit 28 begins measuring the time since the interrupt has occurred;

Step 104: The control circuit 40 consults the timing circuit 38 to determine if the interrupt has been active for longer then a predetermined period of time; if so, go to step 106; if not, go to step 110;

Step 106: Since the interrupt has been active for longer than the predetermined period of time, the monitor circuit 28 resets the PCI bus controller 24 with a PCI reset command PCI_RST to clear the halted interrupt;

Step 108: Since the interrupt was halted and has now been cleared, the monitor circuit 28 transmits an error code to the Doorbell register 26 of the PCI bus controller 24 and informs the host computer 22 with an interrupt; and

Step 110: End.

When a new processor such as a MCU or the DSP 30 is being developed, testing and debugging takes a significant amount of time for the engineers involved. Fortunately, the present invention test setup 20 utilizing the monitor circuit 28 simplifies the tasks of debugging and testing.

Compared to the prior art test setup 10, the present invention test setup 20 can automatically calculate the clock frequency of the DSP 30 in real-time, and eliminates the need to use an oscilloscope to measure the clock frequency. In addition, when updating the executable code of the DSP 30, new executable code is transmitted to the flash memory 32 without the need of a JTAG control chip, thereby reducing the cost and simplifying the design of the test setup 20. Finally, if an interrupt has not been cleared for a predetermined period of time, the monitor circuit 28 automatically resets the PCI bus controller 24 for clearing the interrupt. This saves an engineer the trouble of monitoring the interrupt and manually resetting the PCI bus controller 24 if the interrupt has not been cleared.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of monitoring interrupts transmitted between a processor and a computer used for verifying the processor, the computer and the processor communicating with each other through an interconnect circuit, the method comprising:
detecting a first interrupt transmitted either from the computer to the processor or from the processor to the computer;
measuring a period of time since the first interrupt was generated;
comparing the period of time since the first interrupt was generated with a reference time period if the first interrupt has not yet been cleared;
resetting the interconnect circuit to clear the first interrupt; and
transmitting a second interrupt to the computer to notify the computer that the first interrupt was cleared.

2. The method of claim 1 wherein the processor is a micro controller unit (MCU).

3. The method of claim 1 wherein the processor is a digital signal processor (DSP).

4. The method of claim 1 further comprising sending an error message to the computer through the interconnect circuit after resetting the interconnect circuit to notify the computer that the first interrupt was not cleared.

5. The method of claim 4 wherein the interconnect circuit is a peripheral component interconnect (PCI) bus controller circuit.

6. The method of claim 5 wherein the error message is sent to the computer via a doorbell register of the PCI bus controller circuit.

7. A method of using a computer to verify a clock frequency of a processor, the computer and the processor communicating with each other through an interconnect circuit, the method comprising:
reading a processor clock output from the processor;
counting a number of clock periods of the processor clock occurring during a predetermined number of clock periods of a known clock with a known frequency;
transmitting the counted number of clock periods of the processor clock to the computer through the interconnect circuit;
the computer dividing the counted number of clock periods of the processor clock by the predetermined number of clock periods of the known clock to calculate a clock ratio; and
the computer multiplying the clock ratio by the known frequency of the known clock to calculate the frequency of the processor clock.

8. The method of claim 7 wherein the processor is a micro controller unit (MCU).

9. The method of claim 7 wherein the processor is a digital signal processor (DSP).

10. The method of claim 7 wherein the interconnect circuit is a peripheral component interconnect (PCI) bus controller circuit.

11. The method of claim 10 wherein the counted number of clock periods of the processor clock is transmitted to the computer via a doorbell register of the PCI bus controller circuit.

12. A method of using a computer to update the executable code of a processor, the executable code of the processor being stored in a non-volatile memory electrically connected to the processor, the computer and the processor communicating with each other through an interconnect circuit, the method comprising:
transmitting new code data from the computer to a memory buffer;
transmitting the new code data from the memory buffer directly to the non-volatile memory to update the code data;
reading the updated code data from the non-volatile memory to verify that the updated code data is equivalent to the new code data stored in the memory buffer;
transmitting an interrupt to the computer to notify the computer that the code data was successfully updated;
the computer transmitting a reset command to the processor for resetting the processor; and
the processor executing the updated code data stored in the non-volatile memory after the processor is reset.

13. The method of claim 12 wherein the processor is a micro controller unit (MCU).

14. The method of claim 12 wherein the processor is a digital signal processor (DSP).

15. The method of claim 12 wherein the interconnect circuit is a peripheral component interconnect (PCI) bus controller circuit.

16. The method of claim 15 wherein the counted number of clock periods of the processor clock is transmitted to the computer via a doorbell register of the PCI bus controller circuit.

17. The method of claim 12 wherein the non-volatile memory is a flash memory.
